(19) United States
(12) Patent Application Publication
(10) Pub. No.: US 2005/0145812 A1
(43) Pub. Date: Jul. 7, 2005

(54) Solenoid valve and poppet assembly

(76) Inventor: Viraraghavan S. Kumar, Melbourne, FL (US)

Correspondence Address: The Bilicki Law Firm, P.C., 1285 North Main Street, Jamestown, NY, 14701, US

(21) Appl. No.: 11/026,189

(22) Filed: Dec. 30, 2004

Related U.S. Application Data
(60) Provisional application No. 60/533,562, filed on Dec. 31, 2003.

(51) Int. Cl. F16K 31/02

(52) U.S. Cl. 251/129.15

(57) ABSTRACT

A device comprised of a solenoid portion and a valve unit. The solenoid portion is comprised of a coil with a bore therethrough, a fixed magnetic pole piece substantially within the coil bore, an axially translatable armature forming an axial air gap between the armature and the pole piece, and a biasing mechanism. The valve unit is mechanically coupled to the solenoid valve and comprised of a base member with a chamber, fluid input and exit ports defined by a base member, a valve seat with a valve seat bore, and a poppet assembly within said chamber and mechanically coupled to the armature. The poppet assembly is comprised of a poppet with a lapped surface and a poppet cavity. The lapped surface creates a fluid seal with the valve seat. When the solenoid coil is subject to an electric current, the poppet assembly, mechanically coupled to the armature, axially translates from the valve seat, allowing a fluid to exit the solenoid valve proportional to the electric signal applied to the device. In an alternate embodiment, the armature includes a ferrule-shaped portion disposed thereon, further forming a radial air gap with the magnetic pole piece, whereby the magnetic flux is directed across the radial air gap instead of the axial air gap. In another alternate embodiment of the armature, the ferrule-shaped portion is tapered.

### CROSS-REFERENCE TO RELATED APPLICATIONS

This application claims priority to provisional patent application Ser. No. 60/533,562, filed Dec. 31, 2003, which is a continuation-in-part of and claims priority to non-provisional patent application Ser. No. 09/846,425, filed May 1, 2001 and issued as U.S. Pat. No. 6,715,732 on Apr. 6, 2004, which is a continuation-in-part of and claims priority to non-provisional patent application Ser. No. 09/535,757, filed on Mar. 28, 2000 and issued as U.S. Pat. No. 6,224,033 on May 1, 2001, which is a continuation of and claims priority to application Ser. No. 08/988,369, filed Dec. 10, 1997 and issued as U.S. Pat. No. 6,047,947 on Apr. 11, 2000, which is a continuation-in-part of and claims priority to application Ser. No. 08/632,137, filed Apr. 15, 1996 and issued as U.S. Pat. No. 5,785,298 on Jul. 28, 1998, all of which are incorporated herein in their entireties.

### FIELD OF INVENTION

This invention relates generally to proportional solenoid-controlled fluid valves and poppet assemblies. More particularly, but not by way of limitation, the invention relates a to proportional solenoid-controlled fluid valve, with a custom-fit, poppet assembly, and a method for creating the custom-fit poppet assembly.

### BRIEF DESCRIPTION OF THE DRAWINGS

FIG. 1 shows one embodiment of the entire valve assembly for reference.

FIG. 2 shows an enlarged portion of the valve assembly, similar to that of FIG. 1.

FIG. 3 shows an alternate embodiment of the entire valve assembly.

FIG. 4 shows an enlarged alternate embodiment of a portion of the valve assembly.

FIG. 5 shows an alternate embodiment of the entire valve assembly.

FIG. 6 shows an alternate embodiment of the valve unit portion of the valve assembly.

### DETAILED DESCRIPTION OF EMBODIMENTS OF THE INVENTION

While the device is susceptible to various alternative forms and modifications, specific embodiments will be shown by way of example in the drawings and will be described herein in detail. However, it should be understood that the invention is not intended to be limited to the particular embodiments disclosed. Rather, it is intended that the invention covers all modifications, equivalents, and alternatives following within the spirit and scope of the invention as defined by the claims.

Furthermore, with reference to the drawings, the reader should understand that like reference numerals in different drawings refer to the like elements and components of the invention. The respective elements are generally cylindrically symmetric about an axis of symmetry A. Moreover, it should be noted that every possible alternate embodiment of the invention is not depicted by the figures.

The term “fluid” is used herein to describe any substance with a flow capable of being controlled by a valve, be it a gas or liquid.

Precision fluid flow control devices, such those used in fuel supply units for aerospace systems and oxygen/air metering units employed in hospitals, as non-limiting examples, often incorporate a solenoid-operated valve for controlling fluid flow substantially proportional to the electric signal applied to the solenoid. As the electric signal applied to the solenoid coil increases, a fixed magnetic pole piece becomes more magnetized and an axially translatable armature moves in the direction of the pole piece. The axial translation either opens or closes the valve depending on whether the valve is open or closed when the solenoid is de-energized.

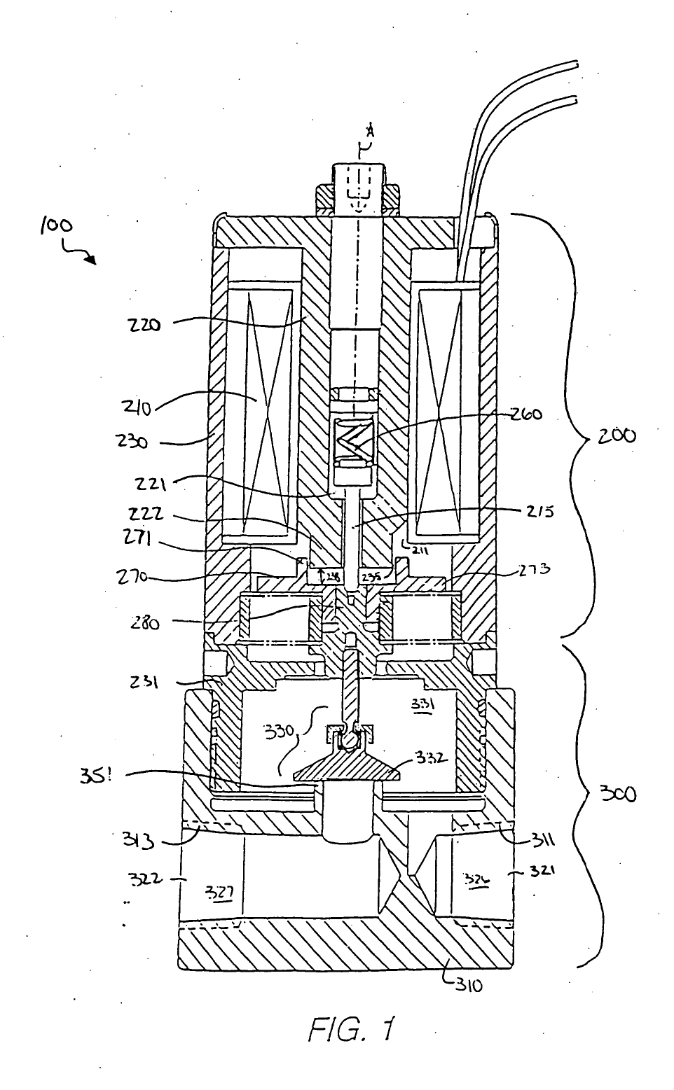

Referring now to the drawings, FIG. 1 shows one embodiment of the entire valve assembly 100 for reference, which is comprised of valve unit 300 and solenoid portion 200, which is mechanically joined to valve unit 300 for controlling operation of valve assembly 100. Valve unit 300 is shown as being threadedly engaged to solenoid portion 200 via housing extension 231, but one of ordinary skill in the art will recognize that valve unit 300 and solenoid portion 200 could be mechanically coupled by any means that prevents fluid leakage therebetween.

In the embodiment shown in FIG. 1, solenoid portion 200 is comprised of solenoid coil 210, with an axial coil bore 211 therethrough, and fixed magnetic pole piece 220 disposed within coil bore 211, both of which are contained within, and supported by, a generally cylindrical magnetic housing 230. However, it should be recognized that valve assembly 100 could be constructed without housing 230, as discussed in detail infra.

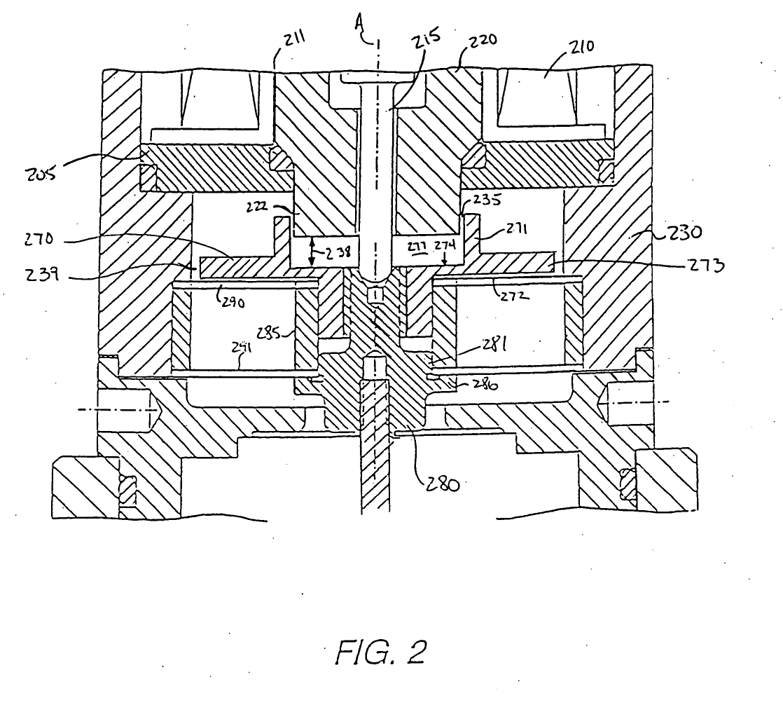

As can more readily be seen in FIG. 2, which shows an enlarged version of a portion of valve assembly 100, similar to that of FIG. 1, generally cylindrical and axially translatable armature 270 can be seen, which is substantially adjacent to end 222 of magnetic pole piece 220 and constrained to only axial movement. End 222 of magnetic pole piece 220 protrudes outside of coil bore 211. Armature 270 is comprised of disc-shaped rim portion 273 and ferrule-shaped portion 271 projecting from armature 270. In addition, armature 270 can be constructed such that rim portion 273 and ferrule-shaped portion 271 are one integral unit or as separate elements fixedly secured to one another. The hollow region, or interior recess 277, of ferrule-shaped portion 271 has an inner diameter that is only slightly larger than the diameter of end 222 of fixed magnetic pole piece 220. This slightly larger diameter allows for relative axial translation of armature 270 between armature 270 and end 222 of magnetic pole piece 220 as armature 270 is attracted to and axially translates towards solenoid coil 210 when energized.

Also visible in FIG. 2 (though not shown in the embodiment of FIG. 1) is annular ring 205 which is made of a non-magnetic material to provide additional structural support. Annular ring 205 is sized to provide a cavity from which end 222 of magnetic pole piece 220 protrudes, and which accommodates axial displacement of ferrule-shaped portion 271 of armature 270.

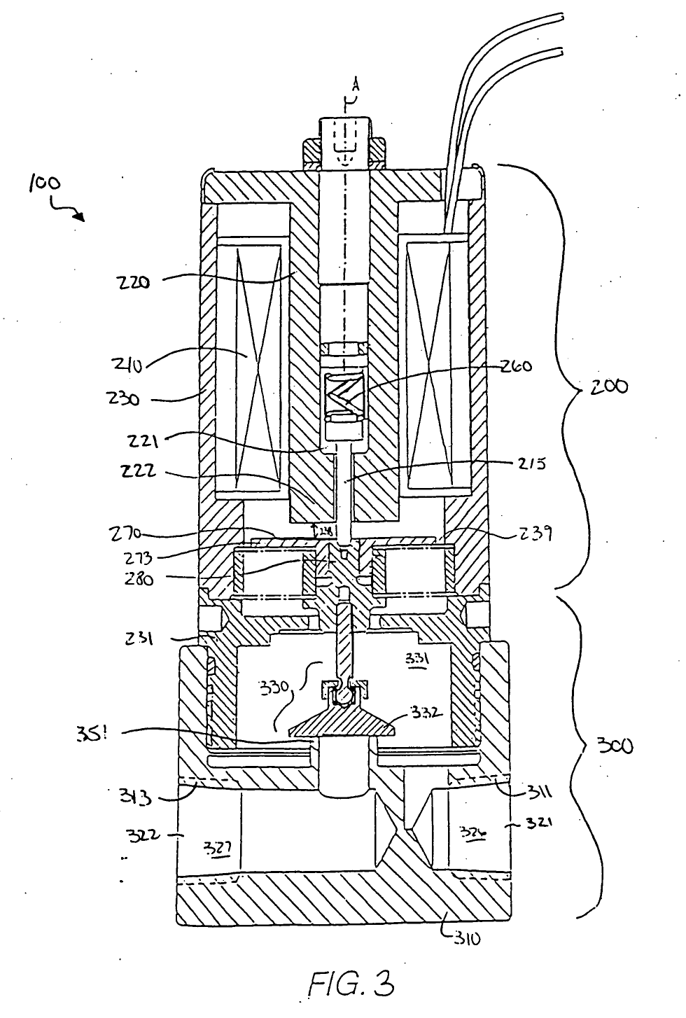

As can also be seen in FIGS. 1 and 2, end 222 of magnetic pole piece 220 is of a smaller diameter than that of the rest of magnetic pole piece 220. However, as can be seen in the embodiment of valve assembly 100 depicted FIG. 3, end 222 need not be of a smaller diameter as compared to the rest of magnetic pole piece 220.

Referring again to FIG. 1, FIG. 1 shows one example of a biasing mechanism. Within magnetic pole piece 220 is pole piece bore 221. At least substantially within pole piece bore 221 is armature-biasing axial pin 215 attached on a distal end to armature 270 and on a proximal end to biasing member 260, which is, in this embodiment, a compression spring. Biasing member 260 maximizes the axial distance between armature 270 and end 222 of magnetic pole piece 220 when solenoid coil 210 is de-energized, and provides the force that must be overcome when solenoid coil 210 is subject to an electric signal.

Armature-biasing axial pin 215 and biasing member 260 comprise one embodiment of the biasing mechanism. One of ordinary skill in the art will recognize that alternate biasing mechanisms could be employed to bias armature 270 away from magnetic pole piece 220. For example, biasing member 260 could be a flexible tube, a star spring with a memory, a sponge, a geo spring, fluid pressure, gravity, or any other means for biasing armature 270 away from magnetic pole piece 220. In addition, instead of biasing member 260 and armature-biasing axial pin 215, the biasing mechanism could be a biasing member, selected from those listed supra, or another, placed within interior recess 277 (see FIG. 2) of armature 270 between and functionally engaging armature 270 and magnetic pole piece 220.

Referring again to FIG. 2, armature retainer 280 can also be seen, which is sized to be threaded into armature 270 and provides one example of an attachment mechanism between armature 270 and armature-biasing axial pin 215. Armature retainer 280 further includes cylindrical wall portion 281, which is sized to receive an inner spring-retaining, ferrule-shaped spacer 285, and also includes a generally flat, rim portion 286, which extends radially from and is solid with wall portion 281. By threading armature retainer 280 into armature 270, first and second spiral-configured suspension spring members 290 and 291, adjoining and mutually spaced apart by spacer 285, are captured between lower face 272 of armature 270 and rim portion 286 of armature retainer 280, thereby providing a support mechanism for armature 270 when solenoid coil 210 is de-energized.

There are two air gaps between armature 270 and magnetic pole piece 220. The first is radial air gap 235 between the outer surface of end 222 of magnetic pole piece 220 and the inner surface of ferrule-shaped portion 271. The second is axial air gap 238 between the bottom surface of end 222 of magnetic pole piece 220 and the circular inner surface 274 within interior recess 277 formed by ferrule-shaped portion 271 of armature 270. Radial air gap 235, a path of low reluctance, shunts a portion of the magnetic flux that normally passes across axial air gap 238, a path of relatively high reluctance.

There is also outer radial air gap 239 between rim portion 273 of armature 270 and housing 230. When solenoid coil 210 is energized, the magnetic flux of the resulting magnetic field follows a closed path through magnetic pole piece 220 to end 222, across radial air gap 235, through ferrule-shaped portion 271 of armature 270, across outer radial air gap 239, to housing 230, and back to magnetic pole piece 220. Thus, axial air gap 238 does not effectively contribute to the magnetic flux path. The result is an effective linearization of the force versus air gap characteristic over a prescribed range, irrespective of the relative axial separation between armature 270 and end 222 of magnetic pole piece 220.

In an alternate embodiment, one or both of radial air gap 235 and outer radial air gap 239 are located within coil bore 211, which requires a non-magnetic spacer (not shown), which is conventionally welded to magnetic elements in order to maintain all of the non-magnetic and magnetic elements in coaxial alignment during the manufacturing process. A welded tube would then be needed, formed using a magnetic material on the ends and a non-magnetic tube in the middle. However, this would require additional construction costs. Locating both radial air gap 235 and outer radial air gap 239 outside of coil bore 211 dispenses with the need for a non-magnetic spacer.

FIG. 3 shows an alternate embodiment of the entire valve assembly 100 in which most of the same components can be seen. The embodiment in FIG. 3 includes an alternate embodiment of armature 270 in which armature 270 does not include the ferrule-shaped portion. As in the embodiment shown in FIGS. 1 and 2, when solenoid coil 210 is energized, the magnetic flux of the resulting magnetic field follows a closed path through magnetic pole piece 220, across axial air gap 238, and through rim portion 273 of armature 270, to housing 230, and back to magnetic pole piece 220, completing the magnetic flux circuit.

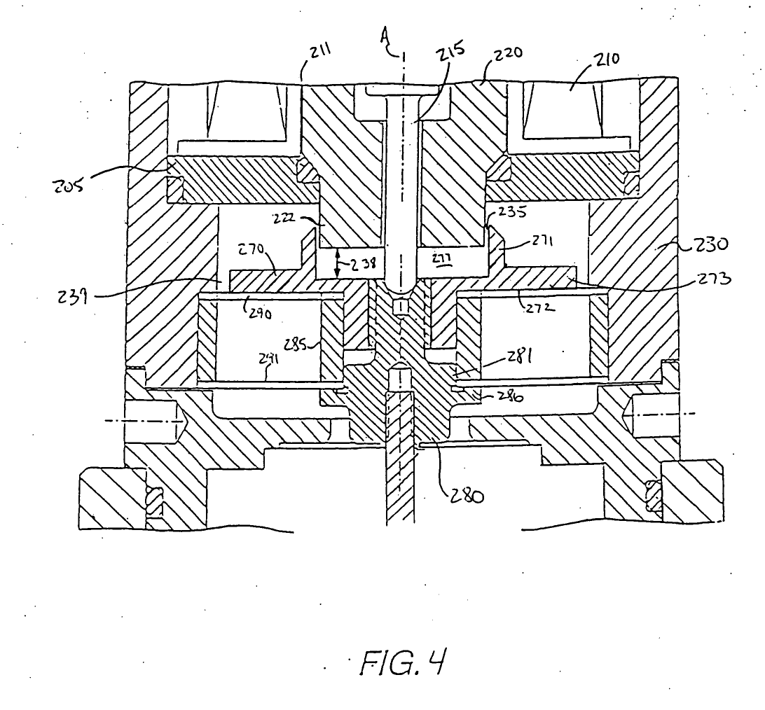

FIG. 4 shows an enlarged embodiment of armature 270 in which ferrule-shaped portion 271 is tapered. The fact that ferrule-shaped portion 271 of armature 270 is tapered, or has a varying thickness in the axial direction, causes this portion of armature 270 become immediately saturated in the course of its diverting magnetic flux that would otherwise pass across axial air gap 238, minimizing hysteresis. Consequently, as in the earlier embodiments described herein, the magnetic flux through armature 270 is principally confined in the radial direction, by-passing the substantial reluctance path along axial air gap 238. This causes the force imparted by solenoid coil 210 on armature 270 to vary in proportion to the applied signal, so that axial displacement of armature 270 against the bias of biasing member 260 varies in proportion to the signal. As in the embodiment shown in FIGS. 1 and 2, when solenoid coil 210 is energized, the magnetic flux of the resulting magnetic field follows a closed path through magnetic pole piece 220, across radial air gap 235, through ferrule-shaped portion 271 of armature 270, jumping outer radial air gap 239 to housing 230, and finally back again to magnetic pole piece 220.

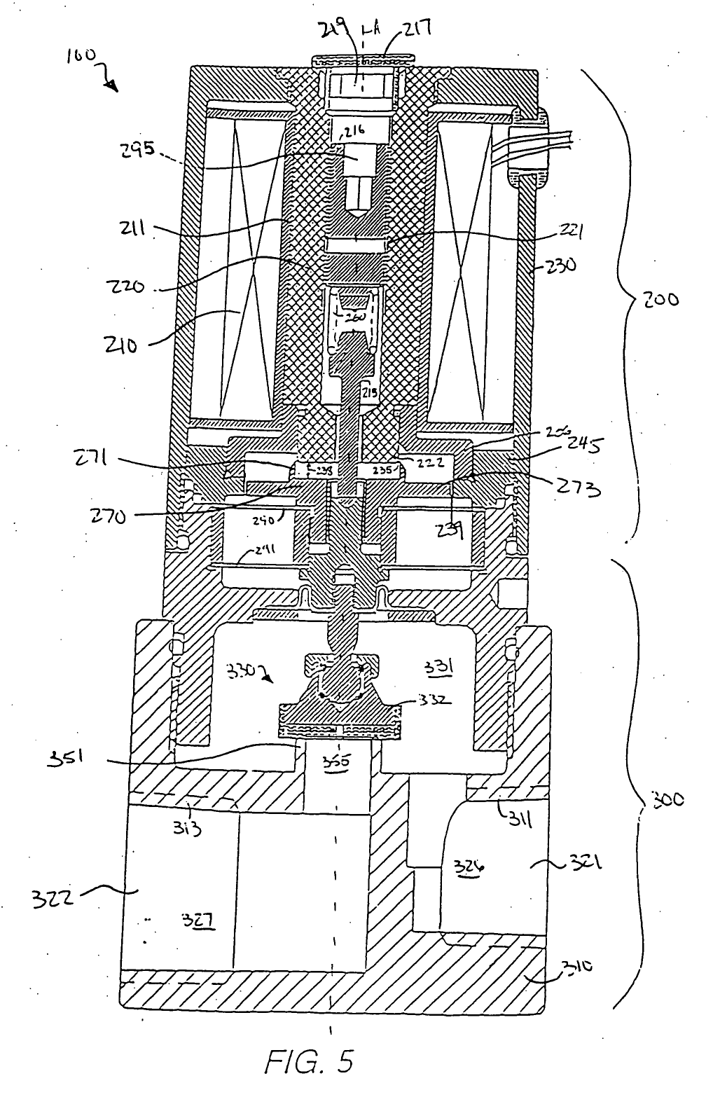

FIG. 5 shows an alternate embodiment of valve assembly 100. Step-shaped annular ring 206, installed atop interior ledge element 245, can be appreciated and supports magnetic pole piece 220 within coil bore 211. Step-shaped annular ring 206 is also sized to provide a cavity from which end 222 of magnetic pole piece 220 protrudes, and which accommodates axial displacement of ferrule-shaped portion 271 of armature 270.

Also visible in FIG. 5, the components of one embodiment of the calibration mechanism can be appreciated. The armature-biasing axial pin 215 provides an externally calibrated spring bias force along axis A against armature 270, so as to establish the amount of force required to axially translate armature 270 away from its closed position (as shown). Calibration member 295 adjusts the amount of force that armature-biasing axial pin 215 exerts on armature 270. In order to calibrate the solenoid actuator, namely, calibrate the amount of force required to axially translate armature 270 along axis A in a direction towards magnetic pole piece 220, where poppet 332 is urged against valve seat 351 and closing valve unit 300, a threaded cylindrical shaft member 216 is threaded into an upper region of pole piece bore 221 of magnetic pole piece 220, and covered by a protective cap 217. A portion of shaft member 216 is sized to fit within one end of biasing member 260, which has an opposite end captured upon a portion of armature-biasing axial pin 215. The degree to which shaft member 216 is threaded into pole piece bore 221 establishes an axially directed spring-bias against armature 270, and thereby against valve seat 351 by poppet 332. Lock nut 219 may be threaded onto an externally threaded end portion of shaft member 216 to prevent further rotation of shaft member 216, once shaft member 216 has been rotated within pole piece bore 221 of magnetic pole piece 220 to establish the desired valve opening force. One of ordinary skill in the art will recognize that alternate calibration mechanisms known in the art can be used to adjust the amount of force which armature 270 must overcome to axially translate towards magnetic pole piece 220.

Magnetic pole piece 220, housing 230, and armature 270 are made of magnetic iron, but could also be made of any magnetic material including magnetic steel, silicon-iron alloys, cold-rolled steel, or any ferro-magnetic material, and each component need not be made of the same magnetic material within the same valve assembly 100.

Furthermore, as stated supra, valve assembly 100 need not include housing 230. If there is no housing, the magnetic flux generated by solenoid coil 210, when subject to an electric signal, must then travel through the air around valve assembly 100 to complete the circuit, and a stronger electric signal is required for proper operation of valve assembly 100. In an alternate embodiment without a housing, a “C-frame” (a C-shaped electrical connector) is used to complete the magnetic flux path.

Referring again to FIG. 1, valve unit 300 can be viewed. Within base member 310 of valve unit 300, fluid input port 321 opens into a first generally cylindrical bore 326. Fluid exit port 322 opens into a second generally cylindrical bore 327. In operation, with the solenoid actuator calibrated by rotation of shaft member 216 in the manner described supra, fluid flow between fluid input port 321 and fluid exit port 322 is established by controlling displacement of poppet 332 relative to valve seat 351, linearly proportional to the signal supplied to solenoid coil 210. With a fluid supply coupled to fluid input port 321, translating poppet 332 away from its closed position against valve seat 351 allows the fluid within fluid flow chamber 331 to flow through valve seat bore 355 to bore 327 and exit valve assembly 100 via fluid exit port 322. As shown in FIGS. 1 and 3, chamber 331 is defined by both housing extension 231 (which is mechanically coupled to housing 230 by means known to those of ordinary skill in the art) and base member 310.

Referring again to FIG. 1, the embodiment of valve unit 300 depicted therein is comprised of generally cylindrical base member 310 having fluid input port 321 into which fluid, the flow rate of which is to be regulated, is introduced, and fluid exit port 322 from which the fluid exits valve unit 300. Fluid input port 321 and fluid exit port 322 may be internally threaded, as shown at internal threadings 311 and 313, respectively, so that valve unit 300 may be installed between respective sections of fluid transporting conduit (not shown). One of ordinary skill in the art will recognize that either fluid input port 321 or fluid exit port 322 could be located along Axis A (i.e., on the bottom surface of base member 310) as opposed to on the sides of base member 310. In the embodiment shown in FIG. 1, base member 310 is made of a non-magnetic material, such as stainless steel, but could also be made of a magnetic material, such as those provided supra.

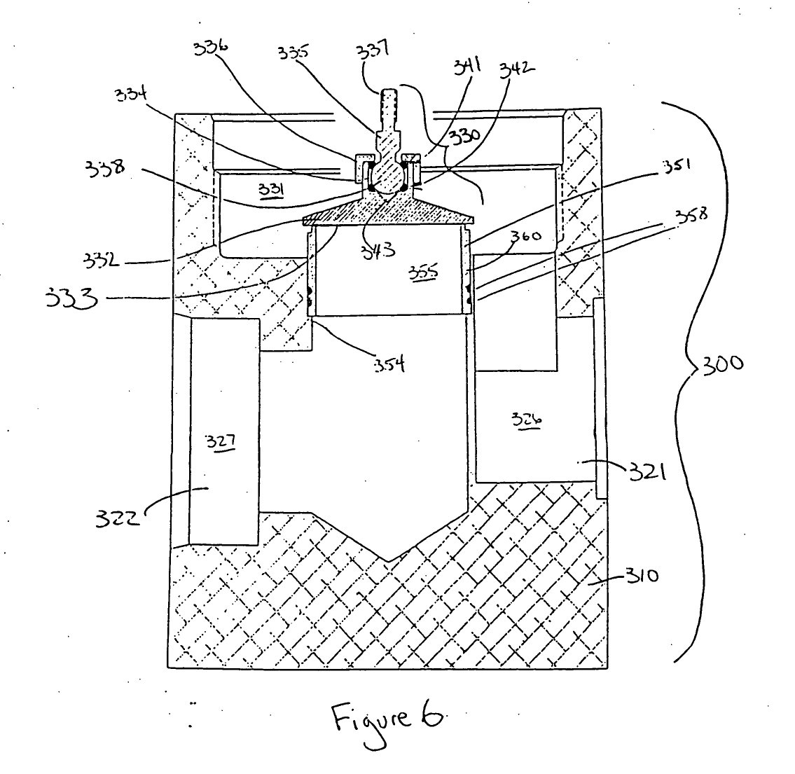

One embodiment of poppet assembly 330 can also be seen in FIG. 1. FIG. 6 shows an enlarged view of an alternate embodiment of poppet assembly 330 and valve seat 351. Poppet assembly 330 is comprised of poppet 332 with lapped surface 333 and poppet cavity 334, poppet balance stem 335 which fits within poppet cavity 334, and poppet cap 336 which holds poppet balance stem 335 within poppet cavity 334. The various components of poppet assembly 330 can be made of magnetic materials, such as those provided supra, or structurally hard non-magnetic materials. One example of a non-magnetic material is stainless steel.

Poppet balance stem 335 has two ends, ball 338 on one end which fits within poppet cavity 334 and distal end 337 at the other end. Distal end 337 is configured to be coupled to the armature (not shown), either directly or via the armature retainer (not shown), such that when the armature is raised or lowered, the entire poppet assembly 330 also raises or lowers. One mechanism for attaching distal end 337 of poppet balance stem 335 to the armature is to use a threading on distal end 337 and a corresponding threading on the armature or the armature retainer and screwing it either directly into the armature or into the armature retainer, which is directly connected to the armature. Thus, when the solenoid coil (not shown) is energized, fluid flow between chamber 331 and valve seat bore 355 is established by controlling displacement of poppet 332 relative to valve seat 351, in linear proportion to the signal supplied to the solenoid coil. Fluid within chamber 331 is allowed to pass underneath poppet assembly 330, through valve seat bore 355, and out of valve unit 300 via fluid exit port 322.

In the embodiment of poppet assembly 330 shown in FIGS. 5 and 6, ball 338 of poppet balance stem 335 has two springs 341, 342 around it when within poppet cavity 334, first spring 341 above the widest part of ball 338 and second spring 342 below. An example of first and second springs 341 and 342 are those manufactured by “Bal-Seal.” In alternate embodiments, only first spring 341 or second spring 342 is included.

Also visible in the embodiment shown in FIGS. 5 and 6, poppet cavity 334 has conical depression 343 to allow for a better fit of ball 338 within poppet cavity 334 which also allows potting compound to essentially completely surround ball 338. One of ordinary skill in the art will recognize that depression 343 could be a shape other than conical and that poppet cavity 334 could be of any other shape capable of containing ball 338.

As can be seen in the alternate embodiment of poppet assembly 330 of FIG. 6, valve seat 351 is comprised of insert 360, which rests atop cylindrical lip 354. Insert 360 can be constructed using any of the materials provided supra for poppet assembly 330. Furthermore, to prevent the unintentional flow of fluid along the outside of valve seat 351, i.e., from passing between insert 360 and base member 310, one or more fluid sealing members 358 can be added. In the embodiment shown in FIG. 6, two fluid sealing members 358 have been added. In this embodiment, fluid sealing members 358 are O-rings. However, as can be seen in FIGS. 1, 3, and 5, valve seat 351 can also be constructed of one piece, contiguous with base member 310, making the need for insert 360, cylindrical lip 354, and fluid sealing member(s) 358 unnecessary.

Whether one piece or two, valve seat 351 of base member 310 projects into chamber 331 to allow a portion of the fluid therein to be under lapped surface 333, reducing the effect of fluid pressure on the axial movement of poppet assembly 330.

In order to have a near perfect fluid seal between poppet assembly 330 and valve seat 351, poppet 332 mounted via a ball-and-socket connection which allows lapped surface 333 of poppet 332 to be an almost perfect alignment with valve seat 351. One method used to create this custom-fit seating between poppet 332 and valve seat 351 is to employ the following procedure. Generally, the method involves:
1) depositing a potting compound (i.e. any substance that has a curing time; e.g., Lock-Tite™ and epoxy) into poppet cavity 334 of poppet 332, coating the surfaces, and filling it approximately half way. If poppet 332 has depression 343, care should be taken to ensure that depression 343 is also filled with the adhesive compound;
2) inserting ball 338 into poppet cavity 334 and retaining it within poppet 332 using poppet cap 336;
3) lowering poppet assembly 330 against valve seat 351 so that lapped surface 333 of poppet 332 is pressed flush against valve seat 351;
4) repeating the lowering step as necessary to ensure that the seating between lapped surface 333 of poppet 332 and valve seat 351 is near perfect; and
5) allowing the adhesive compound to cure so that poppet 332 can no longer pivot around ball 338.
   This results in a custom-fitted poppet for that specific valve, i.e., a “self-leveled poppet.” The effect is a custom-tailored and near perfectly matched poppet assembly 330 for valve seat 351, in which poppet 332 is almost perfectly flush with valve seat 351.

There are many alterations of this method that one of ordinary skill will recognize; nor is the numbering intended to indicate that the steps must be performed in any particular order. By way of example and not intended to be limiting, ball 338 could be inserted into poppet cavity 334 before the potting compound, though it will be more difficult to ensure that the bottom of ball 338 is cemented and that depression 343 is filled with potting compound. Furthermore, depending on the size of the hole in poppet cap 336, the threaded end of poppet balance stem 335 may have to be inserted through the hole in poppet cap 336 before inserting ball 338 into poppet cavity 334.

Although, for convenience, the invention has been described primarily with reference to several specific embodiments, it will be apparent to those of ordinary skill in the art that the valve and the components thereof can be modified without departing from the spirit and scope of the invention as claimed.

1. A device comprised of:
a solenoid portion comprised of:
a generally cylindrical solenoid coil having a longitudinal axis and a coil bore therein, and being operative to produce a magnetic flux with a magnetic flux path when subject to an electric signal;
a generally cylindrical fixed magnetic pole piece disposed within said coil bore and having a distal end projecting from said coil bore;
a generally cylindrical and magnetic axially translatable armature with a ferrule-shaped portion disposed thereon, said ferrule-shaped portion having an inner diameter slightly larger than said distal end of said magnetic pole piece and forming a first radial air gap and an axial air gap therebetween, said first radial air gap substantially reducing an axial magnetic flux of said magnetic flux across said axial air gap; and
a biasing mechanism functionally engaging said magnetic pole piece and said armature and adapted to exert a biasing force on said armature in a direction away from said magnetic pole piece; and
a valve unit mechanically coupled to said solenoid portion, said valve unit comprised of:
a base member, said base member defining a chamber;
a fluid input port and a fluid exit port defined by said base member;
a valve seat with a valve seat bore, said valve seat fluidly adjacent to said chamber and protruding at least partly into said chamber;
a poppet assembly mechanically coupled to said armature and substantially within said chamber, wherein said poppet assembly is comprised of:
a poppet with a lapped surface and a poppet cavity, wherein said lapped surface is capable of creating a fluid seal with said valve seat;
a poppet balance stem with a distal end and a proximal end, said distal end being mechanically coupled to said armature;
a ball on said proximal end of said poppet balance stem, said ball sized to fit within said poppet cavity and making a pivotal connection with said ball; and
a poppet cap for retaining said ball within said poppet cavity;
such that when said solenoid coil is subject to said electric signal, said poppet assembly, being mechanically coupled to said armature, axially translates away from said valve seat, allowing a fluid to pass from said chamber, through said valve seat bore, and out of said device via said fluid exit port in proportion to said electric signal.

2. The device of claim 1, wherein said device is further comprised of a calibration mechanism to establish an amount of force required to axially translate said armature.

3. The device of claim 2, wherein said magnetic pole piece is further comprised of a generally cylindrical axial pole piece bore therewith, said calibration mechanism being disposed substantially within said pole piece bore and comprised of a shaft member, an armature-biasing axial pin with a first end and a second end, said first end of said armature-biasing axial pin functionally engaging said armature and said second end of said armature-biasing axial pin functionally engaging said shaft member, and a calibration member functionally engaging said shaft member, said calibration member configured to adjust said amount of force required to axially translate said armature.

4. The device of claim 1, wherein said magnetic pole piece and said armature are made of a material selected from a magnetic iron, a magnetic steel, a silicon-iron alloy, a cold-rolled steel, and a ferro-magnetic material.

5. The device of claim 1, wherein said device further includes a housing, said housing substantially enclosing said solenoid portion and being of a ferro-magnetic material or further including a C-shaped electrical connector for completing said magnetic flux path.

6. The device of claim 5, wherein said magnetic housing is further comprised of an inwardly projecting tapered portion of said housing and said armature is further comprised of a disc-shaped rim portion, forming a variable geometry radial air gap therebetween, wherein said variable geometry radial air gap aids said first radial air gap in reducing said magnetic flux path across said axial air gap.

7. The device of claim 1, wherein said device is further comprised of a ledge element and said armature is further comprised of a disc-shaped rim portion, said ledge element forming a second radial air gap therebetween, through which said magnetic flux path passes, wherein said second radial air gap aids said first radial air gap in reducing said magnetic flux path across said axial air gap.

8. The device of claim 7, wherein said device further includes an annular ring disposed atop said ledge element to support said pole piece within said solenoid coil bore, said annular ring being made of a non-magnetic material.

9. The device of claim 1, wherein said ferrule-shaped portion of said armature is tapered.

10. The device of claim 1, wherein said biasing mechanism is selected from a group comprised of: gravity; fluid pressure; a biasing member, said biasing member disposed within said ferrule-shaped portion of said armature and selected from a group comprised of a compression spring, a flexible tube, a star spring with a memory, a sponge, and a geo-spring; and a biasing pin with a proximal end and a distal end and said magnetic pole piece is further comprised of a bore substantially therethrough, said biasing pin being at least partially within said bore and said distal end of said biasing pin protruding outside of said pole piece bore, and wherein said distal end is mechanically coupled to said armature and said proximal end is mechanically coupled to a biasing member, said biasing member being selected from a group comprised of a compression spring, a flexible tube, a star spring with a memory, a sponge, and a geo-spring.

11. The device of claim 10, wherein said armature is further comprised of a generally cylindrical bore and an armature retainer disposed within and functionally engaging said armature, wherein said biasing pin is mechanically coupled at said distal end to said armature retainer.

12. The device of claim 1, wherein said armature is supported for axial translation relative to said pole piece by a support mechanism external to said coil bore, wherein said support mechanism is a first and a second flat suspension spring spaced apart from one another and mechanically coupled to said armature.

13. The device of claim 1, wherein said valve seat is defined by said base member.

14. The device of claim 1, wherein said valve seat is further comprised of a cylindrical lip, an insert disposed on said cylindrical lip, and at least one fluid sealing member located between said insert and said base member, wherein said at least one fluid sealing member is selected from a group comprised of an O-ring.

15. The device of claim 5, wherein said housing further includes a housing extension extending at least partially within said base member of said valve unit such that said housing extension and said base member define said chamber within said base member.

16. The device of claim 1, wherein said poppet cavity is further comprised of a depression, and wherein said poppet is locked into a position around said ball using a potting compound such that said lapped surface of said poppet is flush with said valve seat when said solenoid is de-energized.

17. A solenoid valve comprised of:
a solenoid portion comprised of:
a generally cylindrical solenoid coil having a longitudinal axis and a coil bore therein, and being operative to produce a magnetic flux with a magnetic flux path when subject to an electric signal;
a generally cylindrical fixed magnetic pole piece disposed within said coil bore and having a distal end projecting from said coil bore;
a generally cylindrical and magnetic axially translatable armature with a tapered and ferrule-shaped portion disposed thereon, said ferrule-shaped portion having an inner diameter slightly larger than said distal end of said magnetic pole piece and forming a first radial air gap and an axial air gap therebetween, said first radial air gap substantially reducing an axial magnetic flux path across said axial air gap so that, during relative axial translation between said armature and said pole piece, said magnetic flux path is directed in a radial direction across said first radial air gap, substantially by-passing said axial air gap; and
a biasing mechanism functionally engaging said magnetic pole piece and said armature and adapted to exert a biasing force on said armature in a direction away from said magnetic pole piece; and
a valve unit mechanically coupled to said solenoid portion, said valve unit comprised of:
a base member, said base member defining a chamber;
a fluid input port and a fluid exit port defined by said base member;
a valve seat with a valve seat bore, said valve seat fluidly adjacent to said chamber and protruding at least partly into said chamber;
a poppet assembly mechanically coupled to said armature and substantially within said chamber, wherein said poppet assembly is comprised of:
a poppet with a lapped surface and a poppet cavity, wherein said lapped surface is capable of creating a fluid seal with said valve seat;
a poppet balance stem with a distal end and a proximal end, said distal end being mechanically coupled to said armature;
a ball on said proximal end of said poppet balance stem, said ball sized to fit within said poppet cavity and being pivotal connected to said ball; and
a poppet cap for retaining said ball within said poppet cavity, wherein said poppet is locked into a position around said ball using a potting compound such that said lapped surface of said poppet is flush with said valve seat when said solenoid is de-energized;
such that when said solenoid coil is subject to said electric signal, said poppet assembly, being mechanically coupled to said armature, axially translates away from said valve seat, allowing a fluid to pass from said chamber, through said valve seat bore, and out of said solenoid valve via said fluid exit port, varying in proportion to said electric signal.

18. The device of claim 17, wherein said device is further comprised of a calibration mechanism to establish an amount of force required to axially translate said armature.

19. The device of claim 18, wherein said magnetic pole piece is further comprised of a generally cylindrical axial pole piece bore therewith, said calibration mechanism being disposed substantially within said pole piece bore, and said calibration mechanism is comprised of a shaft member, an armature-biasing axial pin with a first end and a second end, said first end of said armature-biasing axial pin functionally engaging said armature and said second end of said armature-biasing axial pin functionally engaging said shaft member, and a calibration member functionally engaging said shaft member, said calibration member configured to adjust said amount of force required to axially translate said armature.

20. The solenoid valve of claim 18, wherein said magnetic pole piece and said armature are made of a material selected from magnetic iron, magnetic steel, a silicon-iron alloy, cold-rolled steel, and a ferro-magnetic material.

21. The solenoid valve of claim 18, wherein said solenoid valve further includes a housing, said housing substantially enclosing said solenoid portion and being of a ferro-magnetic material or further including a C-shaped electrical connector for completing said magnetic flux path.

22. The solenoid valve of claim 21, wherein said magnetic housing is further comprised of an inwardly projecting tapered portion of said housing and said armature is further comprised of a disc-shaped rim portion, forming a variable geometry radial air gap therebetween, wherein said variable geometry radial air gap aids said radial air gap in reducing said magnetic flux path across said axial air gap

23. The solenoid valve of claim 17, wherein said solenoid valve is further comprised of a ledge element and said armature is further comprised of a disc-shaped rim portion, said ledge element forming a second radial air gap therebetween, through which said magnetic flux path passes, wherein said second radial air gap aids said radial air gap in reducing said magnetic flux path across said axial air gap.

24. The solenoid valve of claim 23, wherein said solenoid valve further includes an annular ring disposed atop said ledge element to support said pole piece within said solenoid coil bore, said annular ring being made of a non-magnetic material.

25. The solenoid valve of claim 17, wherein said biasing mechanism is selected from a group comprised of: gravity; fluid pressure; a biasing member, said biasing member disposed within said ferrule-shaped portion of said armature and selected from a group comprised of a compression spring, a flexible tube, a star spring with a memory, a sponge, and a geo-spring; and a biasing pin with a proximal end and a distal end and said magnetic pole piece is further comprised of a bore substantially therethrough, said biasing pin being at least partially within said bore and said distal end of said biasing pin protruding outside of said pole piece bore, and wherein said distal end is mechanically coupled to said armature and said proximal end is mechanically coupled to a biasing member, said biasing member being selected from a group comprised of a compression spring, a flexible tube, a star spring with a memory, a sponge, and a geo-spring.

26. The solenoid valve of claim 25, wherein said armature is further comprised of a generally cylindrical bore and an armature retainer disposed within and functionally engaging said armature, wherein said biasing pin is mechanically coupled at said distal end to said armature retainer.

27. The solenoid valve of claim 17, wherein said armature is supported for axial translation relative to said pole piece by a support mechanism external to said solenoid coil bore, wherein said support mechanism is a first and a second flat suspension spring spaced apart from one another and mechanically coupled to said armature.

28. The solenoid valve of claim 17, wherein said valve seat is defined by said base member or said valve seat is further comprised of a cylindrical lip, an insert disposed on said cylindrical lip, and at least one fluid sealing member located between said insert and said base member, wherein said at least one fluid sealing member is an O-ring.

29. The solenoid valve of claim 21, wherein said housing further includes a housing extension extending at least partially within said base member of said valve unit such that said housing extension and said base member define said chamber within said base member.

30. The solenoid valve of claim 17, wherein said poppet cavity is further comprised of a depression.

31. The solenoid valve of claim 17, wherein said poppet is locked into a position around said ball using a potting compound such that said lapped surface of said poppet is flush with said valve seat when said solenoid is de-energized.

32. A device comprised of:
a base member, said base member defining a chamber:
a fluid input port and a fluid exit port defined by said base member;
a valve seat with a valve seat bore, said valve seat fluidly connected to said chamber and protruding at least partly into said chamber;
a poppet assembly mechanically coupled to said armature and substantially within said chamber, wherein said poppet assembly is comprised of:
a poppet with a lapped surface and a poppet cavity, wherein said lapped surface is capable of creating a fluid seal with said valve seat;
a poppet balance stem with a distal end and a proximal end, said distal end being mechanically coupled to said armature;
a ball on said proximal end of said poppet balance stem, said ball sized to fit within said poppet cavity and making a pivotal connection with said ball; and
a poppet cap for retaining said ball within said poppet cavity.

33. The device of claim 32, wherein said valve unit is capable of being mechanically coupled to a solenoid sub-assembly comprised of a generally cylindrical solenoid coil being operative to produce a magnetic field when subject to an electric signal and having a solenoid bore therein, a generally cylindrical fixed magnetic pole piece disposed substantially within said solenoid bore, a generally cylindrical axially translatable armature external to said solenoid bore, and a biasing mechanism exerting a biasing force on said armature directed away from said magnetic pole piece, wherein when said solenoid coil is subject to said electric signal, said poppet assembly, being mechanically coupled to said armature, axially translates from said valve seat, allowing a fluid to pass from said chamber, through said valve seat bore, and out of said device via said fluid exit port, in proportion to said electric signal.

34. The device of claim 32, wherein said a base member, said poppet, said poppet balance stem, said ball, and said poppet cap are made of a magnetic material or a non-magnetic material.

35. The device of claim 32, wherein said valve seat is defined by said base member.

36. The device of claim 32, wherein said valve seat is further comprised of a cylindrical lip, an disposed on said cylindrical lip and at least one fluid sealing member located between said insert and said base member, wherein said at least one fluid sealing member is selected from a group comprised of an O-ring.

37. The device of claim 33, wherein said solenoid sub-assembly further includes a housing and a housing extension extending at least partially within said base member of said valve unit such that said housing extension and said base member define said chamber within said base member.

38. The device of claim 33, wherein said distal end of said poppet balance stem is mechanically coupled to said armature via an armature retainer within said armature.

39. The device of claim 32, wherein said poppet cavity is further comprised of a depression.

40. The device of claim 32, wherein said poppet is locked into a position around said ball using a potting compound such that said lapped surface of said poppet is flush with said valve seat when said solenoid is de-energized.

41. A method for creating a custom-fit seat between a poppet assembly and a valve seat for use with a solenoid valve comprised of the following steps:
providing a poppet with a lapped surface and a poppet cavity, wherein said lapped surface is capable of creating a fluid seal with said valve seat;
providing a poppet balance stem with a distal end and a proximate end, said distal end capable of being mechanically coupled to an axially translatable armature, and a ball disposed on said proximate end of said poppet balance stem, said ball sized to fit within said poppet cavity and making a pivotal connection to said ball; and
depositing a potting compound into said poppet cavity, wherein said poppet cavity is at least partially filled with said potting compound;
inserting said ball into said poppet cavity;
locking said ball within said poppet cavity with a poppet cap;
lowering said poppet assembly against said valve seat;
repeating said lowering step as necessary to ensure that said lapped surface of said poppet is substantially flush against said lapped valve seat; and
allowing said potting compound to cure so that said poppet can no longer pivot around said ball.

42. The method of claim 41, wherein said valve unit is comprised of a base member with a chamber, a fluid input port, and a fluid exit port, wherein said base member defines said chamber and said poppet assembly is disposed substantially within said chamber.

43. The method of claim 41, wherein said valve unit is capable of being mechanically coupled to a solenoid portion comprised of a generally cylindrical solenoid coil being operative to produce a magnetic field when subject to an electric signal and having a solenoid bore therein, a generally cylindrical fixed magnetic pole piece disposed substantially within said solenoid bore, a generally cylindrically axially translatable armature external to said solenoid bore, and a biasing member exerting a biasing force against said armature in a direction away from said magnetic pole piece.

44. The method of claim 43, wherein when said solenoid coil is subject to said electric current, said poppet assembly, being mechanically coupled to said armature, axially translates from said valve seat, allowing a fluid to pass from said chamber of said base member, through said valve seat bore, and out of said device via said fluid exit port, in proportion to said electric signal.

45. The method of claim 41, wherein said distal end of said poppet balance stem is mechanically coupled to said armature via an armature retainer within said armature.

46. The method of claim 41, wherein said valve seat is further comprised of an insert sitting atop a cylindrical lip and at least one fluid sealing member located between said insert and said base member, said at least one fluid sealing member selected from a group comprised of an O-ring.

47. The method of claim 41, wherein said poppet cavity is further comprised of a depression.
